(19) United States
(12) Patent Application Publication
(10) Pub. No.: US 2025/0363798 A1
(43) Pub. Date: Nov. 27, 2025

(54) MONITORING APPARATUS, MONITORING SYSTEM, MONITORING METHOD, AND NON-TRANSITORY COMPUTER-READABLE MEDIUM

(71) Applicant: NEC CORPORATION, Minato-ku, Tokyo (JP)

(72) Inventors: Yasuhiko OCHIAI, Tokyo (JP); Keisuke INOUE, Tokyo (JP); Motoharu OHTAKE, Tokyo (JP)

(73) Assignee: NEC Corporation, Minato-ku, Tokyo (JP)

(21) Appl. No.: 18/851,854

(22) PCT Filed: Apr. 4, 2022
(86) PCT No.: PCT/JP2022/017060

§ 371 Date: Sep. 27, 2024

(51) Int. Cl. G06V 10/98; G06V 20/54; G06V 40/10; G08G 1/01; G08G 1/052

(52) U.S. Cl. CPC G06V 10/993; G06V 20/54; G06V 40/10; G08G 1/0116; G08G 1/0133; G08G 1/0145; G08G 1/052; G06V 2201/08

(57) ABSTRACT

A monitoring apparatus (10) includes: a camera image acquisition unit (11) that acquires a camera image of a road captured at a first point from a camera disposed at the first point; a traffic information acquisition unit (12) that acquires traffic information indicating a traffic condition of the road at the first point by analyzing the camera image; a road information acquisition unit (13) that acquires road information indicating a traffic-limiting situation at a second point leading to the first point; and an abnormality detection unit (14) that detects an abnormality in the camera image based on the traffic information, statistical information of the traffic information, and the road information.

### TECHNICAL FIELD

The present disclosure relates to a monitoring apparatus, a monitoring system, a monitoring method, and a non-transitory computer-readable medium.

### BACKGROUND ART

A traffic monitoring system is used in which a camera is installed on a road, and a traffic condition or the like is monitored by a captured image. In such a traffic monitoring system, cameras are increasingly installed in various places, demanding efficient maintenance work including abnormality detection after installation.

For example, Patent Literature 1 has been known as a technique related to abnormality detection in a monitoring system. In Patent Literature 1, an abnormality of a learning model that performs a monitoring process in a monitoring system is detected by comparing an output result of the learning model with statistical information that is an expected value thereof.

### CITATION LIST

### Patent Literature

Patent Literature 1: Japanese Unexamined Patent Application Publication No. 2020-113119

### SUMMARY OF INVENTION

### Technical Problem

The traffic monitoring system, which monitors traffic by analyzing a camera image captured by a camera installed on a road, needs to detect an abnormality in the camera image for maintenance. However, the related art such as Patent Literature 1 does not consider its application for detecting an abnormality in a camera image in a traffic monitoring system. For this reason, in the related art, an abnormality in a camera image captured by a camera installed on a road cannot be accurately detected.

In view of such a problem, an object of the present disclosure is to provide a monitoring apparatus, a monitoring system, a monitoring method, and a non-transitory computer-readable medium capable of accurately detecting an abnormality in a camera image.

### Solution to Problem

A monitoring apparatus according to the present disclosure includes: a camera image acquisition means for acquiring a camera image of a road captured at a first point from a camera disposed at the first point; a traffic information acquisition means for acquiring traffic information indicating a traffic condition of the road at the first point by analyzing the camera image; a road information acquisition means for acquiring road information indicating a traffic-limiting situation at a second point leading to the first point; and an abnormality detection means for detecting an abnormality in the camera image based on the traffic information, statistical information of the traffic information, and the road information.

A monitoring system according to the present disclosure includes: a camera disposed at a first point and a monitoring apparatus, in which the monitoring apparatus includes: a camera image acquisition means for acquiring a camera image of a road captured at the first point from the camera; a traffic information acquisition means for acquiring traffic information indicating a traffic condition of the road at the first point by analyzing the camera image; a road information acquisition means for acquiring road information indicating a traffic-limiting situation at a second point leading to the first point; and an abnormality detection means for detecting an abnormality in the camera image based on the traffic information, statistical information of the traffic information, and the road information.

A monitoring method according to the present disclosure includes: acquiring a camera image of a road captured at a first point from a camera disposed at the first point; acquiring traffic information indicating a traffic condition of the road at the first point by analyzing the camera image; acquiring road information indicating a traffic-limiting situation at a second point leading to the first point; and detecting an abnormality in the camera image based on the traffic information, statistical information of the traffic information, and the road information.

A non-transitory computer-readable medium according to the present disclosure stores a monitoring program for causing a computer to execute processing including: acquiring a camera image of a road captured at a first point from a camera disposed at the first point; acquiring traffic information indicating a traffic condition of the road at the first point by analyzing the camera image; acquiring road information indicating a traffic-limiting situation at a second point leading to the first point; and detecting an abnormality in the camera image based on the traffic information, statistical information of the traffic information, and the road information.

### Advantageous Effects of Invention

According to the present disclosure, it is possible to provide a monitoring apparatus, a monitoring system, a monitoring method, and a non-transitory computer-readable medium capable of accurately detecting an abnormality in a camera image.

### BRIEF DESCRIPTION OF DRAWINGS

FIG. 1 is a configuration diagram illustrating an outline of a monitoring apparatus according to an example embodiment.

FIG. 2 is a configuration diagram illustrating a configuration example of a monitoring system according to a first example embodiment.

FIG. 3 is a flowchart illustrating an example of an operation for a statistical information generation process according to the first example embodiment.

FIG. 4 is a flowchart illustrating an example of an operation for a camera abnormality detection process according to the first example embodiment.

FIG. 5 is a flowchart illustrating an example of an operation for a camera abnormality determination process according to the first example embodiment.

FIG. 6 is a configuration diagram illustrating a configuration example of a monitoring system according to a second example embodiment.

FIG. 7 is a configuration diagram illustrating an outline of hardware of a computer according to an example embodiment.

### EXAMPLE EMBODIMENT

Hereinafter, example embodiments will be described with reference to the drawings. In the drawings, the same elements are denoted by the same reference signs, and redundant description will be omitted as necessary.

### Outline of Example Embodiment

When considering a system for monitoring vehicles traveling on a road, such as a traffic monitoring system, the traffic condition of the road is not always constant. For example, if an accident or the like occurs on a monitored road, there is a possibility that traffic volumes at other points may decrease from usual time. In that case, if a detection result of a learning model is simply compared with statistical information as in Patent Literature 1, a deviation, that is, a discrepancy, occurs between the detection result and the statistical information, and thus it is determined that there is an abnormality.

Specifically, in the traffic monitoring system, cameras are installed at a plurality of points on a road, and traffic information including a traffic volume is acquired from camera images captured at the respective points. For example, if an accident occurs at another point connected to the point where the camera is installed, for example, upstream, and the traffic volume changes at the point where the camera is installed, a deviation occurs between the detection result and the statistical information, and thus, there is a possibility that it may be determined that there is an abnormality and an alert may occur.

Here, an abnormality in a camera image detected in an example embodiment is an abnormality that may require maintenance work for the installed camera. That is, the abnormality in the camera image may be an abnormality that occurs entirely or partially in the image due to a camera malfunction such as a camera failure or a dirty camera lens, or an abnormality in the image resulting from a camera malfunction. For example, if the camera fails, an image becomes entirely unrecognizable, and if snow or the like adheres to the lens of the camera, an image becomes partially unrecognizable. The unrecognizable state is, for example, a state in which the image becomes black, blurred, nothing shown, or the like. Therefore, since the abnormality caused when the accident occurs as described above is not an abnormality resulting from a camera malfunction, no abnormality is to be detected in the camera image.

Therefore, in an example embodiment, by considering a road situation at another point connected to the point where the camera is installed, it is possible to accurately detect an abnormality in a camera image.

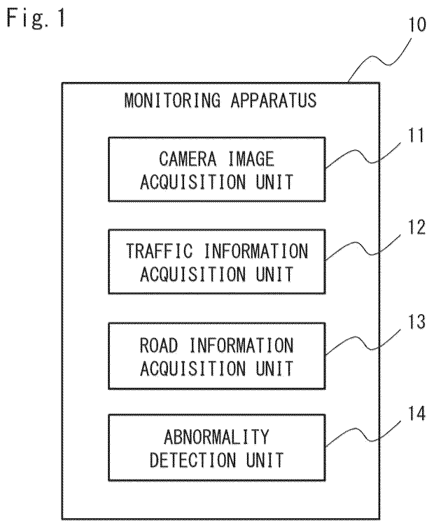

FIG. 1 illustrates an outline of a monitoring apparatus according to an example embodiment. As illustrated in FIG. 1, a monitoring apparatus 10 according to an example embodiment includes a camera image acquisition unit 11, a traffic information acquisition unit 12, a road information acquisition unit 13, and an abnormality detection unit 14.

The camera image acquisition unit 11 acquires a camera image of a road captured at a first point from a camera disposed at the first point. The traffic information acquisition unit 12 acquires traffic information indicating a traffic condition of the road at the first point, by analyzing the camera image acquired by the camera image acquisition unit 11. The road information acquisition unit 13 acquires road information indicating a traffic-limiting situation on the road at a second point leading to the first point. The abnormality detection unit 14 detects an abnormality in the camera image acquired by the camera image acquisition unit 11, based on the traffic information acquired by the traffic information acquisition unit 12, statistical information of the traffic information, and the road information acquired by the road information acquisition unit 13.

As described above, in an example embodiment, an abnormality in a camera image of a first point is detected based on road information at a second point leading to the first point in addition to traffic information obtained from the camera image of the first point and statistical information of the traffic information. As a result, it is possible to determine an abnormality in a camera image of a first point in consideration of road information at a second point, and thus, it is possible to suppress an occurrence of an unnecessary alert and accurately detect the abnormality in the camera image.

### First Example Embodiment

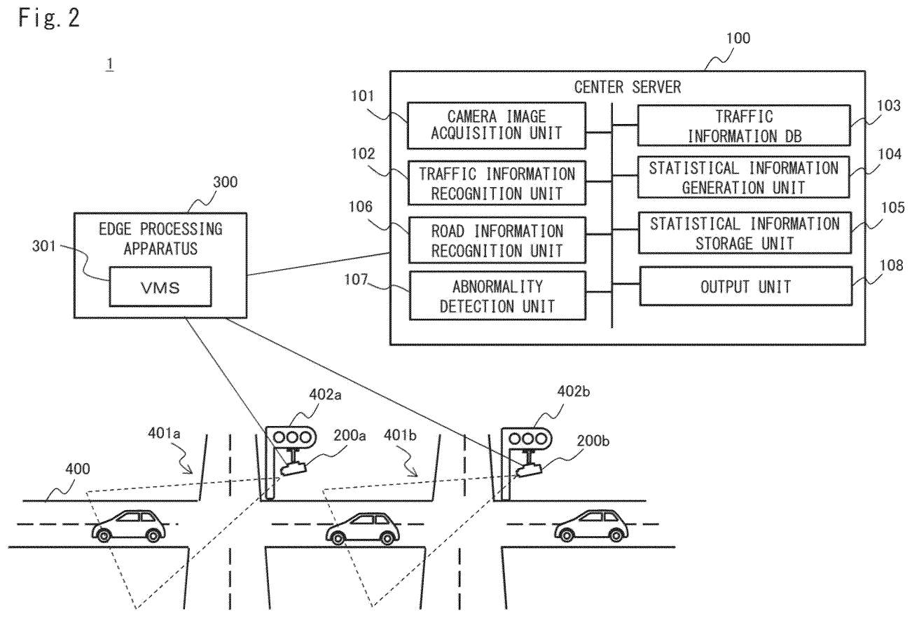

Hereinafter, a first example embodiment will be described with reference to the drawings. FIG. 2 illustrates a configuration example of a monitoring system according to the present example embodiment. The monitoring system 1 according to the present example embodiment is a system that monitors a traffic condition of a road, that is, a traffic flow, and is also a system that detects or monitors an abnormality in a camera image captured by a camera installed or disposed on the road.

As illustrated in FIG. 2, the monitoring system 1 according to the present example embodiment includes a center server 100, a plurality of cameras 200 (e.g., 200a and 200b), and an edge processing apparatus 300. The cameras 200 and the edge processing apparatus 300 are connected to communicate with each other in a wireless or wired manner. In addition, the edge processing apparatus 300 and the center server 100 are also connected to communicate with each other in a wireless or wired manner. The apparatuses may be directly connected to each other, or may be connected to each other via any network. Note that the cameras 200 and the center server 100 may be connected to communicate with each other.

Each of the cameras 200 is a monitoring camera installed or disposed at each point of a road 400 to capture an image of the road 400 at each point. The cameras 200 may capture images of the road 400 at all times, at a periodic timing, or when a certain trigger such as a user operation occurs. The cameras 200 transmit the captured camera images to the edge processing apparatus 300. The camera image may be not only so-called video streaming but also a sequence of still images captured at predetermined timings such as periodic timings. In this example, the camera image is transmitted from the cameras 200 to the center server 100 via the edge processing apparatus 300. Note that the camera image may be transmitted from the cameras 200 to the center server 100 without passing through the edge processing apparatus 300.

For example, each of the cameras 200 is installed at each intersection of the road 400 to be monitored, and captures an image including the road at each intersection. Note that each of the cameras 200 may be installed at any location, not limited to the intersection, as long as it is capable of capturing an image of each point on the road 400. In this example, the camera 200a is installed at an intersection 401a (first point), and the camera 200b is installed at an intersection 401b (second point). For example, the camera 200a is fixed to a traffic light 402a installed at the intersection 401a, and the camera 200b is fixed to a traffic light 402b installed at the intersection 401b. The camera may be fixed to any location, not limited to the traffic light, as long as it is capable of capturing an image of the intersection, which is a monitored point.

A traffic condition at the intersection 401a can be monitored by the camera 200a, and a traffic condition at the intersection 401b can be monitored by the camera 200b. In addition, in this example, the camera 200a at the intersection 401a is set as a camera of which a camera image is an abnormality detection target, and the camera 200b at the intersection 401b is set as a camera for acquiring road information to be used in processing of detecting an abnormality in a camera image of the camera 200a. The intersection 401b is a point leading to the intersection 401a by at least the road 400. For example, the intersection 401b is an intersection upstream of the intersection 401a, but may be an intersection downstream of the intersection 401a. For example, the intersection 401b is an intersection adjacent to the intersection 401a, but may be a closer intersection. A plurality of cameras 200b for acquiring road information may be installed at a plurality of points, not limited to only one camera 200b.

The edge processing apparatus 300 is a server installed or disposed on an edge side of the system, and is, for example, a multi-access edge computing (MEC) apparatus. The edge processing apparatus 300 includes a video management system (VMS) 301. The VMS 301 is an image management unit that manages a camera image of each of the cameras 200. The VMS 301 acquires camera images transmitted from the plurality of cameras 200 (200a and 200b), and transmits the acquired camera images to center server 100. The VMS 301 may change the format or bit rate of the video as necessary. Note that a plurality of edge processing apparatuses 300 may be arranged, and camera images of the plurality of cameras 200 may be transmitted from the plurality of edge processing apparatuses 300 to the center server 100.

The center server 100 is a server installed or disposed on a center side of the system, and is, for example, a cloud server constructed on a cloud. The center server 100 is an apparatus that performs a process of monitoring a traffic condition in the monitoring system 1, and is also an apparatus that performs a process of detecting an abnormality in a camera image.

The center server 100 includes a camera image acquisition unit 101, a traffic information recognition unit 102, a traffic information DB 103, a statistical information generation unit 104, a statistical information storage unit 105, a road information recognition unit 106, an abnormality detection unit 107, and an output unit 108. Note that the configuration of the center server 100 is an example, and another configuration may be used as long as the operation according to the present example embodiment can be performed. Each function of the center server 100 may be realized by one apparatus, or may be realized by a plurality of apparatuses. Some functions of the center server 100 may be arranged in an external apparatus or in the edge processing apparatus 300.

The camera image acquisition unit 101 acquires a camera image captured by each of the cameras 200. In this example, the camera image acquisition unit 101 receives and acquires a camera image of the intersection 401a captured by the camera 200a and a camera image of the intersection 401b captured by the camera 200b via the edge processing apparatus 300.

The traffic information recognition unit 102 is a traffic information acquisition unit that recognizes and acquires traffic information at each point from the camera image of each of the cameras 200 acquired by the camera image acquisition unit 101. In this example, the traffic information recognition unit 102 recognizes traffic information on the road at the intersection 401a from the camera image of the intersection 401a captured by the camera 200a. In addition, the traffic information recognition unit 102 may recognize traffic information at a plurality of points from camera images of a plurality of cameras as necessary. For example, the traffic information recognition unit 102 may recognize traffic information on the road at the intersection 401b from the camera image of the camera 200b, or traffic information at another point from a camera image of another camera 200.

The traffic information is information indicating a traffic condition of a road, that is, a traffic flow. For example, the traffic information includes a traffic volume, a speed, a type, or the like of passing objects passing on the road. The passing objects are not limited to vehicles, and include, for example, people such as pedestrians. The traffic information for vehicles includes a traffic volume of vehicles, speeds of passing vehicles, and vehicle types of passing vehicles, and may be, for example, a traffic volume and a speed for each vehicle type. The traffic volume of vehicles includes the number of vehicles that have passed in a predetermined period. The vehicle types of the vehicles include car, truck, bus, motorcycle, bicycle, or the like. The traffic information for people includes a traffic volume of pedestrians, speeds of pedestrians, and attributes of pedestrians, and may be, for example, a traffic volume and a speed for each attribute. The traffic volume of pedestrians includes the number of people who have passed in a predetermined period. The attributes of the pedestrians include gender, age, or the like.

The traffic information recognition unit 102 may recognize a traffic condition related to a vehicle or a person in a camera image using an artificial intelligence (AI) engine (a learning model using machine learning) for recognition of traffic information. The AI engine may be a convolutional neural network (CNN) or another neural network. For example, by performing machine learning on features of vehicle and pedestrian images and labels of vehicle types of vehicles and attributes of pedestrians, it is possible to recognize vehicle types of vehicles and attributes of pedestrians in an image and acquire a traffic volume and speeds of the recognized vehicles and pedestrians.

The traffic information recognition unit 102 stores the traffic information recognized from the camera image, together with a date and time when the camera image was captured, in the traffic information DB 103 to monitor traffic or generate statistical information. For example, the date and time when the image was captured by the camera 200 is set in the camera image. In a case where the image-captured date and time is not set in the camera image, the date and time when the center server 100 received the camera image may be used. In addition, the traffic information recognition unit 102 outputs the traffic information recognized from the camera image to the abnormality detection unit 107 to detect an abnormality in the camera image.

The traffic information DB 103 is a traffic information storage unit such as a database that stores and accumulates traffic information at each point recognized from the camera image by the traffic information recognition unit 102. The traffic information DB 103 may store a camera image of each point or the like, not limited to the traffic information at each point. For example, the traffic information DB 103 is a non-volatile memory such as a flash memory or a hard disk device.

The statistical information generation unit 104 generates statistical information of the traffic information at each point accumulated in the traffic information DB 103. In this example, the statistical information generation unit 104 generates statistical information of traffic information at the intersection 401a recognized by the traffic information recognition unit 102. In addition, statistical information of traffic information at a plurality of points may be generated as necessary. For example, statistical information of traffic information at the intersection 401b may be generated, or statistical information of traffic information at another point may be generated.

The statistical information generation unit 104 calculates the statistical information of the traffic information at each point based on a result of aggregating the traffic information for a predetermined period. For example, the statistical information is an average value or a total value in the predetermined period, but may be another statistical value such as a variance or an intermediate value. The statistical information may be a statistical value obtained by aggregation for the entire predetermined period, or may be a statistical value obtained by aggregation for each time zone, each day of the week, each month, or the like. For example, the statistical value may be obtained for each time zone of each day of the week. When the traffic information includes traffic information for vehicles and traffic information for people, statistical information for vehicles and statistical information for persons may be obtained. For example, statistical information for each vehicle type with respect to vehicles and statistical information for each attribute with respect to people may be obtained. The statistical information for each vehicle type with respect to vehicles is an average or a sum of traffic volumes, an average of speeds, or the like. The statistical information for each attribute with respect to people is an average or a sum of traffic volumes, a sum of speeds, or the like. The statistical information generation unit 104 stores the generated statistical information at each point in the statistical information storage unit 105.

The statistical information storage unit 105 stores the statistical information of the traffic information at each point generated by the statistical information generation unit 104. For example, similarly to the traffic information DB 103, the statistical information storage unit 105 is a non-volatile memory such as a flash memory or a hard disk device.

The road information recognition unit 106 is a road information acquisition unit that recognizes and acquires road information from the camera image acquired by the camera image acquisition unit 101. In this example, the road information recognition unit 106 recognizes road information on the road at the intersection 401b from the camera image of the intersection 401b captured by the camera 200b. In addition, the road information recognition unit 106 may recognize road information at a plurality of points from camera images of a plurality of cameras as necessary. For example, the road information recognition unit 106 may recognize road information at another point from a camera image of another camera 200, or may recognize road information on the road at the intersection 401a from the camera image of the camera 200a.

The road information is information indicating a traffic-limiting situation on the road. For example, the road information is traffic information at the first point or information regarding an external factor that affects a camera image. For example, the road information is information including information indicating that the road is closed or information indicating that the road is restricted due to an accident, construction, a rock collapse, or the like, or information based thereon. The road information may indicate whether an event that obstructs traffic on the road has occurred, or may indicate a traffic obstruction level. For example, the road information may indicate whether there is a traffic obstruction depending on whether the road is closed. In addition, the road information may indicate a traffic obstruction level depending on the number of restricted lanes, or may indicate a traffic obstruction level depending on whether a person or a vehicle is allowed to pass by type.

The road information recognition unit 106 may recognize an obstruction situation of the road in the camera image using an AI engine for recognition of road information. The AI engine may be a CNN or another neural network. For example, by performing machine learning on features of road closure image and whether there is an obstruction or labels of obstruction levels, it is possible to recognize whether there is an obstruction on the road in the image or an obstruction level. The road information recognition unit 106 outputs the road information recognized from the camera image to the abnormality detection unit 107.

The abnormality detection unit 107 detects an abnormality in the camera image acquired by the camera image acquisition unit 101. It can also be said that the abnormality detection unit 107 detects an abnormality in the camera image resulting from a camera malfunction. In this example, the abnormality detection unit 107 detects an abnormality in the camera image captured by the camera 200a at the intersection 401a. Note that, by a similar detection method, an abnormality in the camera image captured by the camera 200b at the intersection 401b may be detected, or an abnormality in a camera image captured by another camera 200 at another point may be detected.

The abnormality detection unit 107 detects an abnormality in the camera image captured by the camera 200a at the intersection 401a based on the road information at the intersection 401b acquired from the camera image of the camera 200b, the traffic information at the intersection 401a acquired from the camera image of the camera 200a, and the statistical information of the traffic information stored in the statistical information storage unit 105. For example, the abnormality detection unit 107 determines whether there is an abnormality in the camera image of the camera 200a, using the traffic information recognized from the camera image of the camera 200a and the statistical information of the traffic information, according to the road information at the intersection 401b. The determination as to whether there is an abnormality in the camera image of the camera 200a may be made according to road information at a plurality of points.

For example, when the road information indicates that there is no traffic obstruction at the intersection 401b or includes information indicating that there is no traffic obstruction, the abnormality detection unit 107 determines whether there is an abnormality in the camera image of the camera 200a. In addition, when the road information indicates that there is a traffic obstruction at the intersection 401b or includes information indicating that there is a traffic obstruction, the abnormality detection unit 107 detects no abnormality in the camera image of the camera 200a. For example, when there is a traffic obstruction at the intersection 401b, the abnormality detection unit 107 does not need to determine whether there is an abnormality in the camera image of the camera 200a. In this case, a comparison between the traffic information and the statistical information may not be performed, or it may not be determined whether there is an abnormality in the camera image even if a discrepancy between the traffic information and the statistical information is large. In addition, when it is determined that there is an abnormality in the camera image, the abnormality in the camera image of the camera 200a is detected based on the discrepancy between the traffic information and the statistical information at the intersection 401a. The abnormality detection unit 107 may detect whether there is an abnormality in the camera image based on the discrepancy between the traffic information and the statistical information at the intersection 401a, or may detect an abnormality level of the camera image according to a degree of discrepancy. In addition, whether there is an abnormality in the camera image or an abnormality level of the camera image may be detected in consideration of a time for which the state where the discrepancy between the traffic information and the statistical information at the intersection 401a is large lasts.

In a case where the current traffic information based on the camera image of the camera 200a has a great discrepancy from the statistical information indicating the normal state even though there is no traffic obstruction, that is, no external factor, at the intersection 401b, there is a high possibility that the image is abnormal due to a malfunction of the camera 200a. Therefore, when the road information at the intersection 401b indicates that there is no traffic obstruction and current traffic information has a great discrepancy from the statistical information, it can be detected that there is an abnormality in the camera image of the camera 200a. That is, a possibility of abnormality in an image can be detected according to a camera malfunction such a camera failure or a dirty camera lens, for example, whether there is a malfunction or a malfunction level. In other words, it can be detected that there is a possibility of camera malfunction. In addition, if the camera fails, a state where the discrepancy between the current traffic information and the statistical information is large lasts for a long period time. Thus, the possibility of camera malfunction can be reliably detected by the time for which the state where the discrepancy is large lasts.

The output unit 108 outputs a result of detecting whether there is an abnormality in the camera image detected by the abnormality detection unit 107. For example, the output unit 108 is a display device such as a liquid crystal display or an organic electro luminescence (EL) display. The output unit 108 is not limited to the display device, and may include a voice output device or the like. The output unit 108 displays an alarm when an abnormality is detected in the camera image, and the display depends on a detected abnormality level. By displaying a detection result with respect to the camera image captured by each of the cameras 200, an observer can monitor whether each of the camera malfunctions. Furthermore, the output unit 108 may display a camera image captured by each of the cameras 200, traffic information, road information, and the like. For example, by displaying traffic information and road information together with a camera image captured by each of the cameras 200, the observer can monitor traffic at each point.

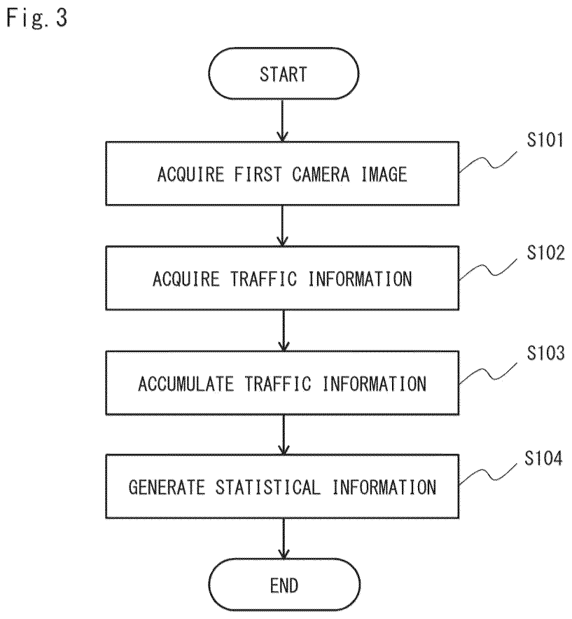

Next, the operation of the center server 100 according to the present example embodiment will be described with reference to FIGS. 3 to 5. FIG. 3 illustrates an example of an operation for a statistical information generation process of the center server 100, which is a flow of a process after a camera image is acquired until statistical information of traffic information is generated. For example, traffic information is acquired and accumulated from a camera image captured by a camera at all times, and statistical information is generated at a predetermined timing. Note that the process of FIG. 3 is executed at least before a process of detecting an abnormality in the camera image.

As illustrated in FIG. 3, the center server 100 acquires a first camera image captured by a first camera set at a first point (S101). The camera 200a (first camera) installed at the intersection 401a (first point) captures an image of a road at all times, for example, at the intersection 401a, and transmits the captured camera image (first camera image) to the edge processing apparatus 300. The edge processing apparatus 300 receives the camera image transmitted from the camera 200a, and transmits the received camera image to the center server 100. In the center server 100, the camera image acquisition unit 101 receives and acquires the camera image of the camera 200a transmitted from the edge processing apparatus 300. The camera image acquisition unit 101 may display the acquired camera image of the camera 200a on the display of the output unit 108.

Next, the center server 100 acquires traffic information from the acquired first camera image (S102). The traffic information recognition unit 102 acquires traffic information on the road at the intersection 401a, by analyzing the camera image of the camera 200a acquired by the camera image acquisition unit 101. The traffic information recognition unit 102 acquires the traffic information on the road at the intersection 401a by inputting the camera image of the camera 200a to an AI engine for recognition of traffic information. The traffic information recognition unit 102 may display the acquired traffic information at the intersection 401a, together with the camera image of the camera 200a, on the display of the output unit 108.

Next, the center server 100 accumulates the acquired traffic information (S103). The traffic information recognition unit 102 stores the traffic information at the intersection 401a acquired from the camera image of the camera 200a in the traffic information DB 103. For example, the traffic information recognition unit 102 sequentially stores and accumulates the traffic information acquired from the camera image captured by the camera 200a at all times, together with image-captured dates and times, in the traffic information DB 103.

Next, the center server 100 generates statistical information of the accumulated traffic information (S104). Referring to the traffic information DB 103, the statistical information generation unit 104 generates statistical information of the accumulated traffic information at the intersection 401a. For example, the statistical information generation unit 104 obtains the statistical information by aggregating traffic information for a predetermined period at a predetermined statistical information generation timing. The statistical information generation timing may be a periodic timing or a timing before an abnormality detection process is started. The statistical information generation unit 104 stores the obtained statistical information of the traffic information at the intersection 401a in the statistical information storage unit 105.

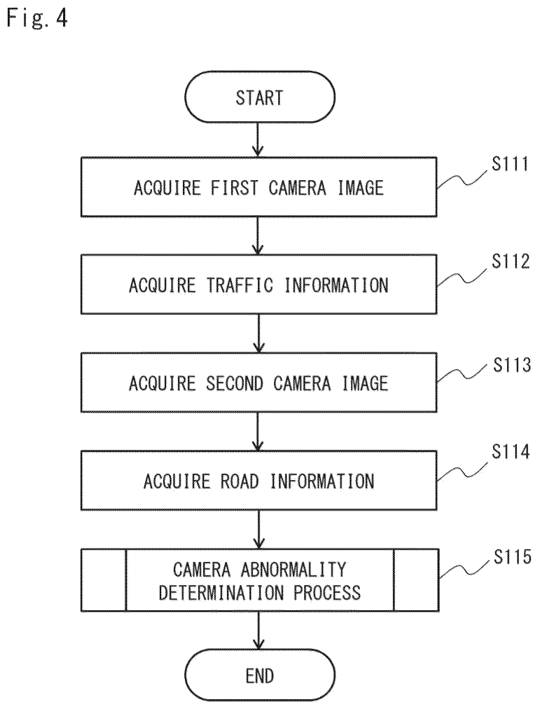

FIG. 4 illustrates an example of an operation for a camera abnormality detection process of the center server 100, which is a flow of a process after a current camera image is acquired until an abnormality is detected in the acquired camera image.

As illustrated in FIG. 4, the center server 100 acquires a first camera image of a first camera installed at a first point (S111). The camera image acquisition unit 101 acquires the camera image from the camera at the first point at an abnormality detection timing for the camera image. The abnormality detection timing may be a periodic timing or a timing specified by the observer. The camera image acquisition unit 101 acquires a camera image (first camera image) of the camera 200a (first camera) installed at the intersection 401a (first point), which is an abnormality detection target, similarly to S101 in FIG. 3.

Next, the center server 100 acquires traffic information from the acquired first camera image (S112). The traffic information recognition unit 102 acquires traffic information at the intersection 401a from the camera image of the camera 200a acquired by the camera image acquisition unit 101, similarly to S102 in FIG. 3.

Next, center server 100 acquires a second camera image of a second camera installed at a second point (S113). The camera image acquisition unit 101 acquires a camera image (second camera image) of the camera 200b (second camera) installed at the intersection 401b (second point) for acquisition of road information, similarly to S111.

Next, the center server 100 acquires road information from the acquired second camera image (S114). The road information recognition unit 106 acquires road information on the road at the intersection 401b, by analyzing the camera image of the camera 200b acquired by the camera image acquisition unit 101. The road information recognition unit 106 acquires the road information on the road at the intersection 401b by inputting the camera image of the camera 200b to an AI engine for recognition of road information.

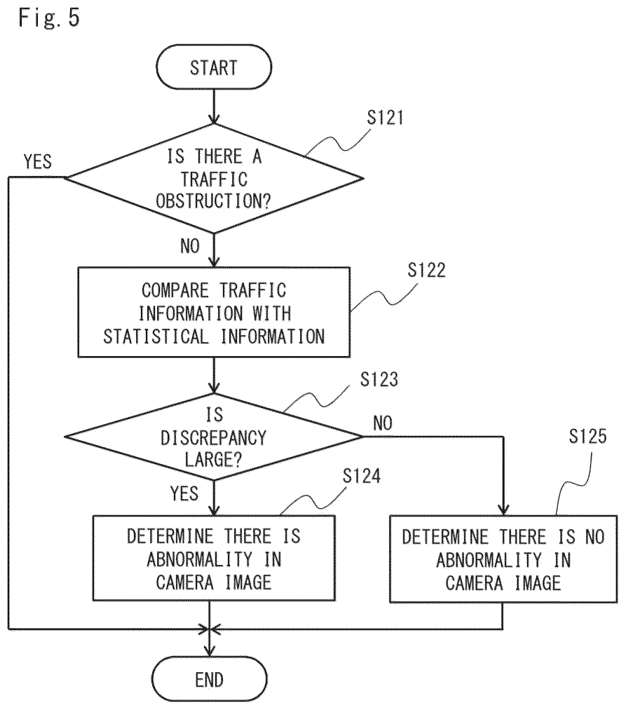

Next, the center server 100 executes a camera abnormality determination process with respect to the first camera image (S115). FIG. 5 illustrates a specific example of the camera abnormality determination process (S115) of FIG. 4.

As illustrated in FIG. 5, the abnormality detection unit 107 determines whether there is a traffic obstruction at the second point (S121). The abnormality detection unit 107 determines whether there is a traffic obstruction at the intersection 401b based on the road information at the intersection 401b (second point) acquired by the road information recognition unit 106 from the camera image of the camera 200b. In a case where road information at a plurality of points is used, the abnormality detection unit 107 determines whether there is a traffic obstruction based on the road information at the plurality of points.

When it is determined that there is no traffic obstruction at the second point (S121/NO), the abnormality detection unit 107 compares the traffic information at the first point with the statistical information (S122). When it is determined that there is a traffic obstruction at the second point (S121/YES), the process ends without determining whether there is an abnormality in the camera image. That is, in this case, the abnormality detection unit 107 detects no abnormality in the camera image. In addition, when the acquired road information indicates that there is no traffic obstruction at the intersection 401b, the abnormality detection unit 107 compares current traffic information acquired by the traffic information recognition unit 102 from the camera image of the camera 200a with the statistical information of the traffic information stored in the statistical information storage unit 105. The current traffic information may be compared with the statistical information when the road information indicates that all traffic, that is, all traffic at one point or at a plurality of points, is not obstructed or indicates that some traffic, that is, some traffic at one point or at a plurality of points, is not obstructed. The process may end when the road information indicates that all traffic is obstructed or when the road information indicates that some traffic is obstructed. Alternatively, the current traffic information may be compared with the statistical information when a traffic obstruction level is lower than the predetermined level, and the process may end when a traffic obstruction level is higher than the predetermined level.

For example, in a case where the statistical information includes statistical information at a plurality of points, statistical information of traffic information at the intersection 401a (camera 200a) is selected, and current traffic information is compared with the selected statistical information. In addition, in a case where the statistical information includes statistical information for each time zone or for each day of the week, statistical information corresponding to the time or the day of the week of current traffic information (the image of the camera 200a) is selected, and current statistical information is compared with the selected statistical information.

Next, the abnormality detection unit 107 determines a magnitude of a discrepancy between the traffic information at the first point and the statistical information (S123), determines that there is an abnormality in the camera image when the discrepancy is large (S123/YES) (S124), and determines that there is no abnormality in the camera image when the discrepancy is small (S123/NO) (S125). The output unit 108 outputs a result of detecting whether there is an abnormality in the camera image from the display or the like.

For example, the abnormality detection unit 107 obtains a discrepancy, that is, a difference, between the current traffic information acquired from the camera image of the camera 200a and the statistical information, and detects an abnormality in the camera image of the camera 200a based on a result of comparing the obtained discrepancy with a predetermined threshold. That is, the abnormality detection unit 107 determines that there is an abnormality in the camera image of the camera 200a when the obtained discrepancy is larger than the predetermined threshold, and determines that there is no abnormality in the camera image of the camera 200a when the discrepancy is smaller than the predetermined threshold.

The predetermined threshold for determining whether there is an abnormality in the camera image may be set in advance. For example, in a case where the traffic information and the statistical information include traffic information and statistical information for vehicles and people, a threshold for vehicles and a threshold for people may be set, or a threshold for each vehicle type with respect to the vehicles and a threshold for each attribute with respect to the people may be set. In this case, it may be determined whether there is an abnormality in the camera image based on a result of comparison with one of the thresholds or all of the thresholds, or it may be determined whether there is an abnormality in the camera image for each threshold. In addition, the predetermined threshold may be set according to road information or the like. For example, the predetermined threshold may be set according to a traffic obstruction level at the intersection 401b indicated by the road information. The predetermined threshold may be set to be larger as the traffic obstruction level is larger, and the predetermined threshold may be set to be smaller as the traffic obstruction level is smaller.

In addition, the abnormality in the camera image may be detected based on a time for which the state where the discrepancy between the current traffic information and the statistical information is large lasts. For example, the abnormality detection unit 107 may determine that there is an abnormality in the camera image when the state where the discrepancy is larger than the predetermined threshold lasts for a predetermined time, and may determine that there is no abnormality in the camera image when the state where the discrepancy is larger than the predetermined threshold does not last for the predetermined time.

In addition, the abnormality detection unit 107 may obtain a discrepancy between the current traffic information acquired from the camera image of the camera 200a and the statistical information, and determine an abnormality level of the camera image of the camera 200a according to a degree or magnitude of the discrepancy. For example, the abnormality level may be determined as one of the three stages including a high level, a medium level, and a low level, or may be determined in a certain number of levels. For example, when it is determined that the degree of discrepancy is large and the abnormality level is a high level, for example, in a case where the number of passing vehicles remains unchanged as 0, there is a possibility that the camera itself may fail. In addition, when it is determined that the degree of discrepancy is small and the abnormality level is a low level, for example, in a case where the number of passing vehicles lasts to be smaller than that indicated by the statistical information, there is a possibility that the camera image is in an abnormal state due to an external factor such as dirt or snow that adheres onto the camera or the lens.

Similarly to the predetermined threshold, the criterion for determining an abnormality level of a camera image or the range thereof may be set in advance, or may be set according to road information or the like. For example, the criterion for determining an abnormality level may be set for each vehicle type with respect to the vehicles or for each attribute with respect to the people. The criterion for determining an abnormality level may be set according to a traffic obstruction level at the intersection 401b indicated by the road information. The abnormality level of the camera image may be determined based on a degree of discrepancy estimated from the traffic obstruction level at the intersection 401b indicated by the road information and a degree of discrepancy between the traffic information and the statistical information.

For example, the abnormality level of the camera image may be determined according to a time for which the state where the discrepancy between the current traffic information and the statistical information lasts. For example, the abnormality detection unit 107 may determine that the abnormality level is a high level when the discrepancy is larger than the predetermined threshold and the state lasts for the predetermined time, and may determine that the abnormality level is a low level when the discrepancy is larger than the predetermined threshold and the state does not last for the predetermined time.

As described above, in the present example embodiment, in a monitoring system that monitors a traffic condition of a road, a determination as to whether there is an abnormality in a camera image of a camera installed on the road is made based on road information at another point on the road. For example, in a case where there is a traffic obstruction due to a road closure or the like at another point, there is a high possibility that an external factor at another point affects a camera image, and thus, a determination as to whether there is an abnormality in the camera image is not made. In a case where there is no traffic obstruction at another point, there is a high possibility that a factor of the camera itself affects a camera image, and therefore, a determination as to whether there is an abnormality in the camera image is made. As a result, it is possible to prevent an image abnormality caused by an external factor at another point from being determined as an abnormality in a camera image, and thus, it is possible to improve accuracy in detecting an abnormality in the camera image. In addition, the processing load can be reduced by not performing a determination as to whether there is an abnormality.

### Second Example Embodiment

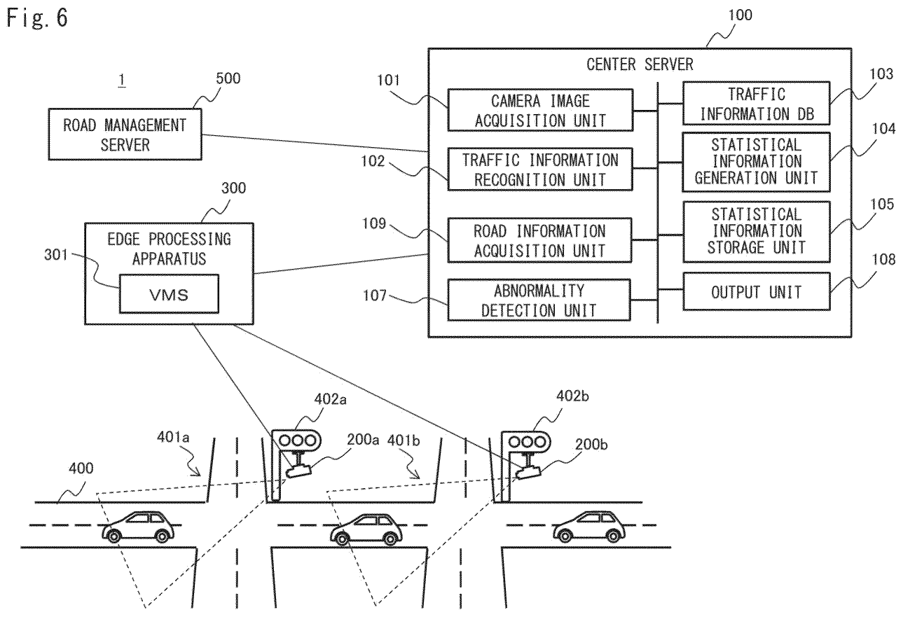

Hereinafter, a second example embodiment will be described with reference to the drawings. FIG. 6 illustrates a configuration example of a system according to the present example embodiment.

As illustrated in FIG. 6, a monitoring system 1 according to the present example embodiment includes a road management server 500 in addition to the configuration of the first example embodiment. The center server 100 and the road management server 500 are connected to communicate with each other.

The road management server 500 is a management server that manages road information, and is, for example, a vehicle information and communication system (VICS) server or the like. The road management server 500 collects and manages road information including road closures and restrictions due to accidents, construction, and the like based on various sensors installed at each point of the road, input information, and the like. For example, the road management server 500 manages road information at the intersection 401b on the road 400.

In addition, the center server 100 includes a road information acquisition unit 109 instead of the road information recognition unit 106 of the first example embodiment. The road information acquisition unit 109 acquires road information at the intersection 401b from the road management server 500. Note that the road information acquisition unit 109 may acquire road information at the intersection 401b based on various sensors installed at the intersection 401b, input information, and the like.

In the present example embodiment, the abnormality detection unit 107 detects an abnormality in the camera image of the camera 200a based on the traffic information at the intersection 401a recognized by the traffic information recognition unit 102 from the camera image of the camera 200a, the statistical information stored in the statistical information storage unit 105, and the road information at the intersection 401b acquired by the road information acquisition unit 109. The other configurations and the abnormality detection method are similar to those in the first example embodiment. In this manner, even when road information is acquired from the road management server or the like that manages road information, it is possible to improve accuracy in detecting an abnormality in the camera image as in the first example embodiment.

Note that the present disclosure is not limited to the above-described example embodiments, and can be appropriately changed without departing from the gist. For example, in the above-described example embodiments, an abnormality in the camera image at the first point is determined in consideration of road information at the second point, but an abnormality in a camera image at the first point may be determined in consideration of road information at the first point.

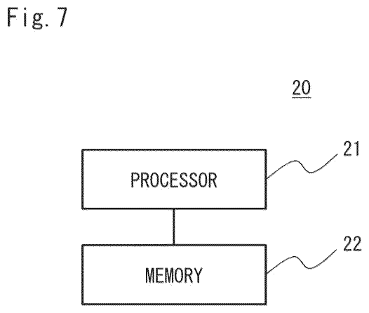

Each configuration in the above-described example embodiments may be implemented by hardware, software, or both, and may be implemented by one piece of hardware or software or by a plurality of pieces of hardware or software. Each device and each function (process) may be realized by a computer 20 including a processor 21, such as a central processing unit (CPU), and a memory 22, which is a storage device, as illustrated in FIG. 7. For example, programs for performing the methods (the monitoring method and the abnormality detection method) in the example embodiments may be stored in the memory 22, and the functions may be realized by the processor 21 executing the programs stored in the memory 22.

These programs include a group of instructions (or software codes) causing a computer to perform one or more of the functions described in the example embodiments when read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. As an example and not by way of limitation, the transitory computer-readable medium or the communication medium includes an electrical signal, an optical signal, an acoustic signal, or any other form of propagated signal.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following supplementary notes, but are not limited to the following supplementary notes.

### Supplementary Note 1

A monitoring apparatus including:
a camera image acquisition means for acquiring a camera image of a road captured at a first point from a camera disposed at the first point;
a traffic information acquisition means for acquiring traffic information indicating a traffic condition of the road at the first point by analyzing the camera image;
a road information acquisition means for acquiring road information indicating a traffic-limiting situation at a second point leading to the first point; and
an abnormality detection means for detecting an abnormality in the camera image based on the traffic information, statistical information of the traffic information, and the road information.

### Supplementary Note 2

The monitoring apparatus according to supplementary note 1, in which the abnormality detection means determines whether there is an abnormality in the camera image, using the traffic information and the statistical information, according to the road information.

### Supplementary Note 3

The monitoring apparatus according to supplementary note 2, in which the abnormality detection means determines whether there is an abnormality in the camera image when the road information includes information indicating that there is no traffic obstruction at the second point.

### Supplementary Note 4

The monitoring apparatus according to supplementary note 3, in which in the determination as to whether there is an abnormality in the camera image, the abnormality detection means detects the abnormality in the camera image based on a discrepancy between the traffic information and the statistical information.

### Supplementary Note 5

The monitoring apparatus according to supplementary note 4, in which the abnormality detection means detects the abnormality in the camera image based on a result of comparing the discrepancy with a predetermined threshold.

### Supplementary Note 6

The monitoring apparatus according to supplementary note 5, in which the abnormality detection means sets the predetermined threshold according to a traffic obstruction level at the second point indicated by the road information.

### Supplementary Note 7

The monitoring apparatus according to any one of supplementary notes 2 to 5, in which the abnormality detection means detects no abnormality in the camera image when the road information includes information indicating that there is a traffic obstruction at the second point.

### Supplementary Note 8

The monitoring apparatus according to any one of supplementary notes 1 to 7, in which the abnormality detection means determines an abnormality level of the camera image according to a degree of discrepancy between the traffic information and the statistical information.

### Supplementary Note 9

The monitoring apparatus according to supplementary note 8, in which the abnormality detection means determines the abnormality level of the camera image based on a degree of discrepancy estimated from a traffic obstruction level at the second point indicated by the road information, and the degree of discrepancy between the traffic information and the statistical information.

### Supplementary Note 10

The monitoring apparatus according to any one of supplementary notes 1 to 9, in which the abnormality detection means detects the abnormality in the camera image resulting from a camera malfunction.

### Supplementary Note 11

The monitoring apparatus according to any one of supplementary notes 1 to 10, in which the road information acquisition means acquires the road information from a camera image captured by a camera disposed at the second point.

### Supplementary Note 12

The monitoring apparatus according to any one of supplementary notes 1 to 10, in which the road information acquisition means acquires road information at the second point from a management apparatus that manages the road information.

### Supplementary Note 13

The monitoring apparatus according to any one of supplementary notes 1 to 12, in which
the road information acquisition means acquires a plurality of pieces of road information at a plurality of second points, and
the abnormality detection means detects the abnormality in the camera image based on the plurality of pieces of road information.

### Supplementary Note 14

The monitoring apparatus according to any one of supplementary notes 1 to 13, in which the road information includes information indicating that the road is closed or information indicating that the road is restricted.

### Supplementary Note 15

The monitoring apparatus according to any one of supplementary notes 1 to 14, in which the traffic information includes a traffic volume, a speed, or a type of a passing object passing on the road.

### Supplementary Note 16

The monitoring apparatus according to supplementary note 15, in which the passing object includes a vehicle or a person.

### Supplementary Note 17

The monitoring apparatus according to any one of supplementary notes 1 to 16, further including a statistical information storage means for storing the statistical information of the traffic information,
in which the abnormality detection means detects the abnormality in the camera image based on the stored statistical information.

### Supplementary Note 18

The monitoring apparatus according to any one of supplementary notes 1 to 17, further including a statistical information generation means for generating the statistical information based on a result of aggregating the traffic information in a predetermined period.

### Supplementary Note 19

The monitoring apparatus according to any one of supplementary notes 1 to 18, in which the statistical information includes statistical information for each time zone, for each day of the week, or for each month.

### Supplementary Note 20

A monitoring system including a camera disposed at a first point and a monitoring apparatus,
in which the monitoring apparatus includes:
   a camera image acquisition means for acquiring a camera image of a road captured at the first point from the camera;
   a traffic information acquisition means for acquiring traffic information indicating a traffic condition of the road at the first point by analyzing the camera image;
   a road information acquisition means for acquiring road information indicating a traffic-limiting situation at a second point leading to the first point; and
   an abnormality detection means for detecting an abnormality in the camera image based on the traffic information, statistical information of the traffic information, and the road information.

### Supplementary Note 21

The monitoring system according to supplementary note 20, in which the abnormality detection means determines whether there is an abnormality in the camera image, using the traffic information and the statistical information, according to the road information.

### Supplementary Note 22

A monitoring method including:
acquiring a camera image of a road captured at a first point from a camera disposed at the first point;
acquiring traffic information indicating a traffic condition of the road at the first point by analyzing the camera image;
acquiring road information indicating a traffic-limiting situation at a second point leading to the first point; and
detecting an abnormality in the camera image based on the traffic information, statistical information of the traffic information, and the road information.

### Supplementary Note 23

The monitoring method according to supplementary note 22, in which in the detection of the abnormality, it is determined whether there is an abnormality in the camera image, using the traffic information and the statistical information, according to the road information.

### Supplementary Note 24

A non-transitory computer-readable medium storing a monitoring program for causing a computer to execute processing including:
acquiring a camera image of a road captured at a first point from a camera disposed at the first point;
acquiring traffic information indicating a traffic condition of the road at the first point by analyzing the camera image;
acquiring road information indicating a traffic-limiting situation at a second point leading to the first point; and
detecting an abnormality in the camera image based on the traffic information, statistical information of the traffic information, and the road information.

### Supplementary Note 25

The non-transitory computer-readable medium according to supplementary note 24, in which in the detection of the abnormality, it is determined whether there is an abnormality in the camera image, using the traffic information and the statistical information, according to the road information.

### Reference Signs List

1 MONITORING SYSTEM

10 MONITORING APPARATUS

11 CAMERA IMAGE ACQUISITION UNIT

12 TRAFFIC INFORMATION ACQUISITION UNIT

13 ROAD INFORMATION ACQUISITION UNIT

14 ABNORMALITY DETECTION UNIT

20 COMPUTER

21 PROCESSOR

22 MEMORY

100 CENTER SERVER

101 CAMERA IMAGE ACQUISITION UNIT

102 TRAFFIC INFORMATION RECOGNITION UNIT

103 TRAFFIC INFORMATION DB

104 STATISTICAL INFORMATION GENERATION UNIT

105 STATISTICAL INFORMATION STORAGE UNIT

106 ROAD INFORMATION RECOGNITION UNIT

107 ABNORMALITY DETECTION UNIT

108 OUTPUT UNIT

109 ROAD INFORMATION ACQUISITION UNIT

200, 200a, 200b CAMERA

300 EDGE PROCESSING APPARATUS

400 ROAD

401, 401a, 401b INTERSECTION

402, 402a, 402b TRAFFIC LIGHT

500 ROAD MANAGEMENT SERVER

What is claimed is:

1. A monitoring apparatus comprising:
at least one memory storing instructions, and
at least one processor configured to execute the instructions stored in the at least one memory to;
acquire, by a camera, an image of a road captured at a first point;
determine, by analyzing the image, traffic information indicating a traffic condition of the road at the first point;
acquire road information indicating whether or not there is a traffic-limiting situation at a second point leading to the first point; and
detect an abnormality in the image based on the traffic information and the road information.

2. The monitoring apparatus according to claim 1, wherein the at least one processor is further configured to execute the instructions stored in the at least one memory to cause, according to the road information, the detection of the abnormality in the image using the traffic information and statistical information of the traffic information.

3. The monitoring apparatus according to claim 2, wherein the at least one processor is further configured to execute the instructions stored in the at least one memory to cause, based on the road information indicating there is no traffic-limiting situation at the second point, the detection of the abnormality in the image.

4. The monitoring apparatus according to claim 2, wherein the at least one processor is further configured to execute the instructions stored in the at least one memory to detect the abnormality in the image based on a discrepancy between the traffic information and the statistical information.

5. The monitoring apparatus according to claim 4, wherein the at least one processor is further configured to execute the instructions stored in the at least one memory to detect the abnormality in the image based on a result of comparing the discrepancy with a threshold.

6. The monitoring apparatus according to claim 5, wherein the at least one processor is further configured to execute the instructions stored in the at least one memory to set the threshold according to a traffic obstruction level at the second point indicated by the road information.

7. The monitoring apparatus according to claim 2, wherein the at least one processor is further configured to execute the instructions stored in the at least one memory to detect no abnormality in the image, based on the road information indicating that there is a traffic-limiting situation at the second point.

8. The monitoring apparatus according to claim 1, wherein the at least one processor is further configured to execute the instructions stored in the at least one memory to determine an abnormality level of the image according to a degree of discrepancy between the traffic information and statistical information of the traffic information.

9. The monitoring apparatus according to claim 8, wherein the at least one processor is further configured to execute the instructions stored in the at least one memory to determine the abnormality level of the image based on a degree of discrepancy estimated from a traffic obstruction level at the second point indicated by the road information, and based on the degree of discrepancy between the traffic information and the statistical information.

10. The monitoring apparatus according to claim 1, wherein the at least one processor is further configured to execute the instructions stored in the at least one memory to detect the abnormality in the image resulting from a camera malfunction.

11. The monitoring apparatus according to claim 1, wherein the at least one processor is further configured to execute the instructions stored in the at least one memory to acquire the road information from an image captured by a camera disposed at the second point.

12. The monitoring apparatus according to claim 1, wherein the at least one processor is further configured to execute the instructions stored in the at least one memory to acquire the road information at the second point from a management apparatus that manages the road information.

13. The monitoring apparatus according to claim 1, wherein
the at least one processor is further configured to execute the instructions stored in the at least one memory to acquire a plurality of pieces of the road information at a plurality of second points, and
detect the abnormality in the image based on the plurality of pieces of the road information.

14. The monitoring apparatus according to claim 1, wherein the road information includes information indicating that the road is closed or information indicating that the road is restricted.

15. The monitoring apparatus according to claim 1, wherein the traffic information includes a traffic volume, a speed, or a type of an object passing on the road.

16. The monitoring apparatus according to claim 15, wherein the object includes a vehicle or a person.

17. The monitoring apparatus according to claim 1, wherein the at least one processor is further configured to execute the instructions stored in the at least one memory to store statistical information of the traffic information, and
detect the abnormality in the image based on the stored statistical information.

18. The monitoring apparatus according to claim 1, wherein the at least one processor is further configured to execute the instructions stored in the at least one memory to generate the statistical information based on a result of aggregating the traffic information in a predetermined period.

19. (canceled)

20. A monitoring system comprising a camera disposed at a first point and a monitoring apparatus,
wherein the monitoring apparatus includes:
at least one memory storing instructions, and
at least one processor configured to execute the instructions stored in the at least one memory to;
acquire, by the camera, an image of a road captured at the first point;
determine, by analyzing the image, traffic information indicating a traffic condition of the road at the first point;
acquire road information indicating whether or not there is a traffic-limiting situation at a second point leading to the first point; and
detect an abnormality in the image based on the traffic information and the road information.

21. (canceled)

22. A monitoring method comprising:
acquiring, by a camera, an image of a road captured at a first point;
determining, by analyzing the image, traffic information indicating a traffic condition of the road at the first point;
acquiring road information indicating whether or not there is a traffic-limiting situation at a second point leading to the first point; and
detecting an abnormality in the image based on the traffic information and the road information.

23-25. (canceled)
